(19) United States
(12) Patent Application Publication
(10) Pub. No.: US 2015/0161232 A1
(43) Pub. Date: Jun. 11, 2015

(54) NOISE-ENHANCED CLUSTERING AND COMPETITIVE LEARNING

(71) Applicants: Bart Kosko, Hacienda Heights, CA (US); Osonde Osoba, Los Angeles, CA (US)

(72) Inventors: Bart Kosko, Hacienda Heights, CA (US); Osonde Osoba, Los Angeles, CA (US)

(73) Assignee: UNIVERSITY OF SOUTHERN CALIFORNIA, Los Angeles, CA (US)

(21) Appl. No.: 14/553,890

(22) Filed: Nov. 25, 2014

Related U.S. Application Data
(60) Provisional application No. 61/914,294, filed on Dec. 10, 2013.

(51) Int. Cl. G06F 17/30; G06N 3/08; G06F 17/10; G06T 7/00; G06K 9/62

(52) U.S. Cl. CPC G06F 17/30598; G06T 7/0012; G06K 9/6217; G06F 17/10; G06N 3/088

(57) ABSTRACT

Non-transitory, tangible, computer-readable storage media may contain a program of instructions that enhances the performance of a computing system running the program of instructions when segregating a set of data into subsets that each have at least one similar characteristic. The instructions may cause the computer system to perform operations comprising: receiving the set of data; applying an iterative clustering algorithm to the set of data that segregates the data into the subsets in iterative steps; during the iterative steps, injecting perturbations into the data that have an average magnitude that decreases during the iterative steps; and outputting information identifying the subsets.

### CROSS-REFERENCE TO RELATED APPLICATION

This application is based upon and claims priority to U.S. provisional patent application 61/914,294, entitled “NOISE ENHANCED CLUSTERING AND COMPETITIVE LEARNING ALGORITHMS,” filed Dec. 10, 2013, attorney docket number 028080-0958. The entire content of this application is incorporated herein by reference.

### BACKGROUND

1. Technical Field

This disclosure relates to noise-enhanced clustering algorithms.

2. Description of Related Art

Clustering algorithms divide data sets into clusters based on similarity measures. The similarity measure attempts to quantify how samples differ statistically. Many algorithms use the Euclidean distance or Mahalanobis similarity measure. Clustering algorithms assign similar samples to the same cluster. Centroid-based clustering algorithms assign samples to the cluster with the closest centroid μ₁, . . . , μₖ.

This clustering framework attempts to solve an optimization problem. The algorithms define data clusters that minimize the total within-cluster deviation from the centroids. Suppose yᵢ are samples of a data set on a sample space D. Centroid-based clustering partitions D into the k decision classes D₁, . . . , Dₖ of D. The algorithms look for optimal cluster parameters that minimize an objective function. The k-means clustering method minimizes the total sum of squared Euclidean within-cluster distances:

$${\sum }_{j = 1}^{K} {\sum }_{i = 1}^{N} {‖ {y}_{i} - {μ}_{j} ‖}^{2} {II}_{{D}_{j}} ( {y}_{i} ) \qquad ( 1 )$$

where I_{D}_{ⱼ} the indicator function that indicates the presence or absence of pattern y in Dⱼ:

$${II}_{{D}_{j}} ( y ) = \{ \begin{matrix}1 & if y ∈ {D}_{j} \\ 0 & if y ∉ {D}_{j}\end{matrix} . \qquad ( 2 )$$

There are many approaches to clustering. Cluster algorithms come from fields that include nonlinear optimization, probabilistic clustering, neural networks-based clustering, fuzzy clustering, graph-theoretic clustering, agglomerative clustering, and bio-mimetic clustering.

Maximum likelihood clustering algorithms can benefit from noise injection. This noise benefit derives from the application of the Noisy Expectation Maximization (NEM) theorem to the Expectation Maximization (EM) clustering framework. The next section reviews the recent NEM Theorem and applies it to clustering algorithms.

Competitive Learning Algorithms

Competitive learning algorithms learn centroidal patterns from streams of input data by adjusting the weights of only those units that win a distance-based competition or comparison. Stochastic competitive learning behaves as a form of adaptive quantization because the trained synaptic fan-in vectors (centroids) tend to distribute themselves in the pattern space so as to minimize the mean-squared-error of vector quantization. Such a quantization vector also converges with probability one to the centroid of its nearest-neighbor class. We will show that most competitive learning systems benefit from noise. This further suggests that a noise benefit holds for ART systems because they use competitive learning to form learned pattern categories.

Unsupervised competitive learning (UCL) is a blind clustering algorithm that tends to cluster like patterns together. It uses the implied topology of a two-layer neural network. The first layer is just the data layer for the input patterns y of dimension d. There are K-many competing neurons in the second layer. The synaptic fan-in vectors to these neurons define the local centroids or quantization vectors μ₁, . . . , μ_{K}. Simple distance matching approximates the complex nonlinear dynamics of the second-layer neurons competing for activation in an on-center/off-surround winner-take-all connection topology as in a an ART system. Each incoming pattern stimulates a new competition. The winning jth neuron modifies its fan-in of synapses while the losing neurons do not change their synaptic fan-ins. Nearest-neighbor matching picks the winning neuron by finding the synaptic fan-in vector closest to the current input pattern. Then the UCL learning law moves the winner's synaptic fan-in centroid or quantizing vector a little closer to the incoming pattern.

The UCL algorithm may be written as a two-step process of distance-based “winning” and synaptic-vector update. The first step is the same as the assignment step in k-means clustering. This equivalence alone argues for a noise benefit. But the second step differs in the learning increment. So UCL differs from k-means clustering despite their similarity. This difference prevents a direct subsumption of UCL from the E-M algorithm. It thus prevents a direct proof of a UCL noise benefit based on the NEM Theorem.

In all simulations, the initial K centroid or quantization vectors may equal the first K random pattern samples: μ₁(1)=y(1), . . . , μ_{K}(K)=y(K). Other initialization schemes could identify the first K quantizing vectors with any K other pattern samples so long as they are random samples. Setting all initial quantizing vectors to the same value can distort the learning process. All competitive learning simulations used linearly decaying learning coefficients cⱼ(t)=0.3(1−t/1500).

### Unsupervised Competitive Learning (UCL) Algorithm

Pick the Winner:
The j^{th} neuron wins at t if

∥y(t)−μⱼ(t)∥≦∥y(t)−μₖ(t)∥k≠j. (3)

### Update the Winning Quantization Vector:

μⱼ(t+1)=μⱼ(t)+cᵢ└y(t)−μⱼ(t)┘ (4)

for a decreasing sequence of learning coefficients {cₜ}.

A similar stochastic difference equation can update the covariance matrix Σⱼ of the winning quantization vector:

Σⱼ(t+1)=Σⱼ(t)+cₜ[(y(t)−μⱼ(t))^{T}(y(t)−μⱼ(t))−Σⱼ(t)]. (5)

A modified version can update the pseudo-covariations of alpha-stable random vectors that have no higher-order moments. The simulations in this paper do not adapt the covariance matrix.

The two UCL steps (3) and (4) may be rewritten into a single stochastic difference equation. This rewrite requires that the distance-based indicator function ∥_{D}_{ⱼ} the pick-the-winner step (3), just as it does for the assign-samples step (26) of k-means clustering:

μⱼ(t+1)=μⱼ(t)+cₜ∥_{D}_{ⱼ}(y(t))└y(t)−μⱼ(t)┘. (6)

The one-equation version of UCL in (6) more closely resembles Grossberg's original deterministic differential-equation form of competitive learning in neural modeling:

\dot{m}ᵢⱼ=Sⱼ(yⱼ)└Sᵢ(xᵢ)−mᵢⱼ┘ (7)

where mᵢⱼ is the synaptic memory trace from the i^{th} neuron in the input field to the j^{th} neuron in the output or competitive field. The input neuron has a real-valued activation xᵢ that feeds into a bounded nonlinear signal function (often a sigmoid) Sᵢ. The j^{th} competitive neuron likewise has a real-valued scalar activation yⱼ that feeds into a bounded nonlinear signal function Sⱼ. But competition requires that the output signal function Sⱼ approximate a zero-one decision function. This gives rise to the approximation Sⱼ≈∥_{D}_{ⱼ}.

The two-step UCL algorithm is the same as Kohonen's “self-organizing map” algorithm if the self-organizing map updates only a single winner. (Kohonen, T. (1990). The self-organizing map. Proceedings of the IEEE, 78, 1464-1480; Kohonen, T. (2001). Self-organizing maps. Springer.) Both algorithms can update direct or graded subsets of neurons near the winner. These near-neighbor beneficiaries can result from an implied connection topology of competing neurons if the square K-by-K connection matrix has a positive diagonal band with other entries negative.

Supervised competitive learning (SCL) punishes the winner for misclassifications. This requires a teacher or supervisor who knows the class membership Dⱼ of each input pattern y and who knows the classes that the other synaptic fan-in vectors represent. The SCL algorithm moves the winner's synaptic fan-in vector μⱼ away from the current input pattern y if the pattern y does not belong to the winner's class Dⱼ. So the learning increment gets a minus sign rather than the plus sign that UCL would use. This process amounts to inserting a reinforcement function r into the winner's learning increment as follows:

$$\begin{matrix}{μ}_{j} ( t + 1 ) = {μ}_{j} ( t ) + {c}_{t} {r}_{j} ( y ) ⌊ y - {μ}_{j} ( t ) ⌋ & ( 8 ) \\ {r}_{j} ( y ) = {II}_{{D}_{j}} ( y ) - {\sum }_{i \neq j} {II}_{{D}_{i}} ( y ) . & ( 9 )\end{matrix}$$

Russian learning theorist Ya Tsypkin appears the first to have arrived at the SCL algorithm. He did so in 1973 in the context of an adaptive Bayesian classifier. (Tsypkin, Y. Z. (1973). Foundations of the theory of learning systems. Academic Press.)

Differential Competitive Learning (DCL) is a hybrid learning algorithm. It replaces the win-lose competitive learning term Sⱼ in (7) with the rate of winning \dot{S}ⱼ. The rate or differential structure comes from the differential Hebbian law:

\dot{m}ᵢⱼ=−mᵢⱼ+\dot{S}ᵢ\dot{S}ⱼ (10)

using the above notation for synapses mᵢⱼ and signal functions Sᵢ and Sⱼ. The traditional Hebbian learning law just correlates neuron activations rather than their velocities. The result is the DCL differential equation:

\dot{m}ᵢⱼ=\dot{S}ⱼ(yⱼ)[Sᵢ(xᵢ)−mᵢⱼ]. (11)

Then the synapse learns only if the j^{th} competitive neuron changes its win-loss status. The synapse learns in competitive learning only if the j^{th} neuron itself wins the competition for activation. The time derivative in DCL allows for both positive and negative reinforcement of the learning increment. This polarity resembles the plus-minus reinforcement of SCL even though DCL is a blind or unsupervised learning law. Unsupervised DCL compares favorably with SCL in some simulation tests.

DCL may be submitted with the following stochastic difference equation:

μⱼ(t+1)=μⱼ(t)+cₜΔSⱼ(zⱼ)└S(y)−uⱼ(t)┘ (12)

μᵢ(t+1)=μᵢ(t) if i≠j (13)

when the j^{th} synaptic vector wins the metrical competition as in UCL. ΔSⱼ(zⱼ) is the time-derivative of the j^{th} output neuron activation. We approximate it as the signum function of time difference of the training sample z:

ΔSⱼ(zⱼ)=sgn└zⱼ(t+1)−zⱼ(t)┘. (14)

The k-means, k-medians, self-organizing maps, UCL, SCL, DCL and related approaches can take a long time before they converge to optimal clusters. And the final solutions may usually only be locally optimal.

### SUMMARY

Non-transitory, tangible, computer-readable storage media may contain a program of instructions that enhances the performance of a computing system running the program of instructions when segregating a set of data into subsets that each have at least one similar characteristic. The instructions may cause the computer system to perform operations comprising: receiving the set of data; applying an iterative clustering algorithm to the set of data that segregates the data into the subsets in iterative steps; during the iterative steps, injecting perturbations into the data that have an average magnitude that decreases during the iterative steps; and outputting information identifying the subsets.

The iterative clustering algorithm may include a k-means clustering algorithm.

The instructions may cause the computer system to apply at least one prescriptive condition on the injected perturbations.

At least one prescriptive condition may be a Noisy Expectation Maximization (NEM) prescriptive condition.

The iterative clustering algorithm may include a parametric clustering algorithm that relies on parametric data fitting.

The iterative clustering algorithm may include a competitive learning algorithm.

The perturbations may be injected by adding them to the data.

The average magnitude of the injected perturbations may decrease with the square of the iteration count during the iterative steps.

The average magnitude of the injected perturbations may decrease to zero during the iterative steps.

The average magnitude of the injected perturbations may decrease to zero at the end of the iterative steps.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 shows a simulation instance of the corollary noise benefit of the NEM Theorem for a two-dimensional Gaussian mixture model with three Gaussian data clusters.

FIG. 2 shows a similar noise benefit in the simpler k-means clustering algorithm on 3-dimensional Gaussian mixture data.

FIG. 3 shows that noise injection speeded up UCL convergence by about 25%.

FIG. 4 shows that noise injection speeded up SCL convergence by less than 5%.

FIG. 5 shows that noise injection speeded up DCL convergence by about 20%.

FIG. 6 shows how noise can also reduce the centroid estimate's jitter in the UCL algorithm.

FIG. 7 shows a computer system with storage media containing a program of instructions.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

The approaches that are now described may reduce the time it takes to get clustering results that are closer to optimal. They may also increase the chance of finding more robust clusters in the face of missing or corrupted data.

Noise can provably speed up convergence in many centroid-based clustering algorithms. This includes the popular k-means clustering algorithm. The clustering noise benefit follows from the general noise benefit for the expectation-maximization algorithm because many clustering algorithms are special cases of the expectation-maximization algorithm. Simulations show that noise also speeds up convergence in stochastic unsupervised competitive learning, supervised competitive learning, and differential competitive learning.

Information below shows that noise can speed convergence in many clustering algorithms. This noise benefit is a form of stochastic resonance: small amounts of noise improve a nonlinear system's performance while too much noise harms it. This noise benefit applies to clustering because many of these algorithms are special cases of the expectation-maximization (EM) algorithm. An appropriately noisy EM algorithm converges more quickly on average than does a noiseless EM algorithm. The Noisy Expectation Maximization (NEM) Theorem 1 discussed below restates this noise benefit for the EM algorithm.

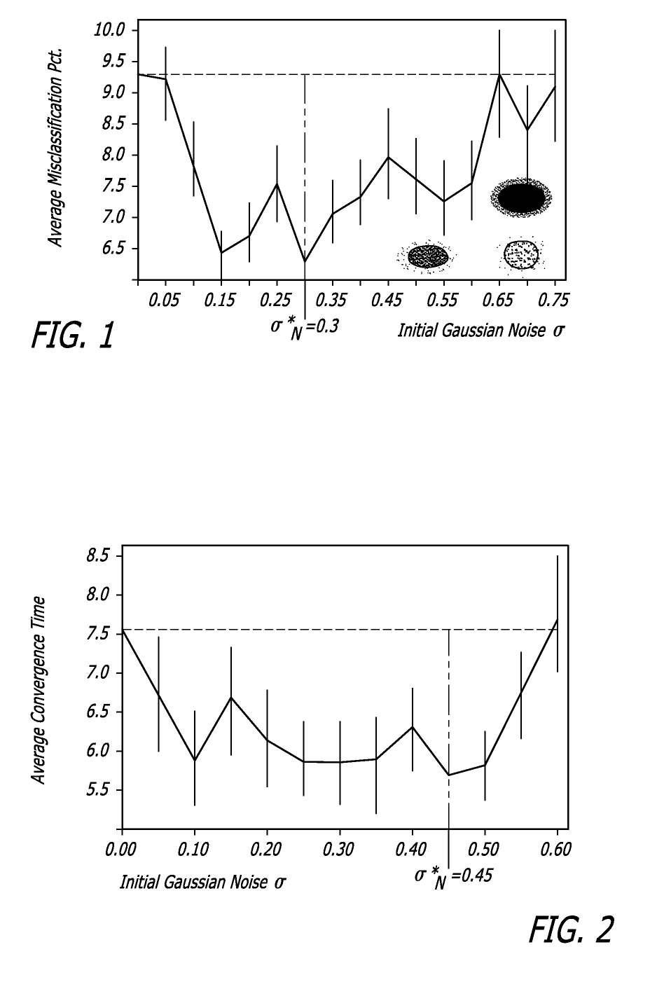

FIG. 1 shows a simulation instance of the corollary noise benefit of the NEM Theorem for a two-dimensional Gaussian mixture model with three Gaussian data clusters. The noise benefit is based on the misclassification rate for the Noisy Expectation-Maximization (NEM) clustering procedure on a 2-D Gaussian mixture model with three Gaussian data clusters (inset) where each has a different covariance matrix. The plot shows that the misclassification rate falls as the additive noise power increases. The classification error rises if the noise power increases too much. The misclassification rate measures the mismatch between a NEM classifier with unconverged parameters Θₖ and the optimal NEM classifier with converged parameters Θ*. The unconverged NEM classifier's NEM procedure stops a quarter of the way to convergence. The dashed horizontal line indicates the misclassification rate for regular EM classification without noise. The dashed vertical line shows the optimum noise standard deviation for NEM classification. The optimum noise has a standard deviation of 0.3.

Theorem 3 below states that such a noise benefit will occur. Each point on the curve reports how much two classifiers disagree on the same data set. The first classifier is the EM-classifier with fully converged EM-parameters. This is the reference classifier. The second classifier is the same EM-classifier with only partially converged EM-parameters. The two classifiers agree eventually if the second classifier's EM-parameters are allowed converge. But the Fig. shows that they agree faster with some noise than with no noise.

The normalized number of disagreements may be called the misclassification rate. The misclassification rate falls as the Gaussian noise power increases from zero. It reaches a minimum for additive white noise with standard deviation 0.3. More energetic noise does not reduce misclassification rates beyond this point. The optimal noise reduces misclassification by almost 30%.

FIG. 2 shows a similar noise benefit in the simpler k-means clustering algorithm on 3-dimensional Gaussian mixture data. The noise benefit is in k-means clustering procedure on 2500 samples of a 3-D Gaussian mixture model with four clusters. The plot shows that the convergence time falls as additive white Gaussian noise power increases. The noise decays at an inverse square rate with each iteration. Convergence time rises if the noise power increases too much. The dashed horizontal line indicates the convergence time for regular k-means clustering without noise. The dashed vertical line shows the optimum noise standard deviation for noisy k-means clustering. The optimum noise has a standard deviation of 0.45: the convergence time falls by about 22%.

The k-means algorithm is a special case of the EM algorithm as shown below in Theorem 2. So the EM noise benefit extends to the k-means algorithm. The Fig. plots the average convergence time for noise-injected k-means routines at different initial noise levels. The Fig. shows an instance where decaying noise helps the algorithm converge about 22% faster than without noise.

The Noisy EM Algorithm

The regular Expectation-Maximization (EM) algorithm is a maximum likelihood procedure for corrupted or missing data. Corruption can refer to the mixing of subpopulations in clustering applications. The procedure seeks a maximizer θ* of the likelihood function:

$${Θ}_{*} = {argmax}_{Θ} ln f ( y \vert Θ ) . \qquad ( 15 )$$

The EM algorithm iterates an E-step and an M-step:

### EM Algorithm

Q(θ|θₖ)←E_{Z|Y,θ}_{ₖ}[f(y,z|θ)] E-Step

θₖ₊₁←argmax_{θ}{Q(θ|θₖ)}. M-Step

NEM Theorem

The Noisy Expectation Maximization (NEM) Theorem states a general sufficient condition when noise speeds up the EM algorithm's convergence to the local optimum. The NEM Theorem uses the following notation. The noise random variable N has pdf f(n|Y). So the noise N can depend on the data Y. {θₖ} is a sequence of EM estimates for θ. θ*=lim_{k→∞}θₖ is the converged EM estimate for θ. Define the noisy Q function Q_{N}(θ|θₖ)=E_{Z|Y,θ}_{ₖ}[ln f(y+N, z|θ)]. Assume that the differential entropy of all random variables is finite. Assume also that the additive noise keeps the data in the likelihood function's support. Then we can state the NEM theorem.

Theorem 1: Noisy Expectation Maximization (NEM)

The E-M estimation iteration noise benefit

Q(θ*|θ*)−Q(θₖ|θ*)≧Q(θ*|θ*)−Q_{N}(θₖ|θ*) (16)

or equivalently

Q_{N}(θₖ|θ*)≧Q(θₖ|θ*) (17)

holds if the following positivity condition holds on average:

$${E}_{Y , Z , N \vert {θ}^{*}} [ ln ( \frac{f ( Y + N , Z \vert {θ}_{k} )}{f ( Y , Z \vert {θ}_{k} )} ) ] \geq 0. \qquad ( 18 )$$

The NEM Theorem states that a suitably noisy EM algorithm estimates the EM estimate θ* in fewer steps on average than does the corresponding noiseless EM algorithm.

The Gaussian mixture EM model in the next section greatly simplifies the positivity condition in (18). The model satisfies the positivity condition (18) when the additive noise samples n=(n₁, . . . n_{d}) satisfy the following algebraic condition:

nᵢ└nᵢ−2(μⱼ_{ᵢ}−yᵢ)┘≦0 forallj. (19)

This condition applies to the variance update in the EM algorithm. It needs the current estimate of the centroids μⱼ. The NEM algorithm also anneals the additive noise by multiplying the noise power σ_{N} by constants that decay with the iteration count. The best application of the algorithm has been found to use inverse-square decaying constants:

s[k]=k⁻² (20)

where s[k] scales the noise N by a decay factor of k⁻² on the k^{th} iteration. The annealed noise Nₖ=k⁻²T must still satisfy the NEM condition for the model. Then the decay factor s[k] reduces the NEM estimator's jitter around its final value. All noise-injection simulations used this annealing cooling schedule to gradually reduce the noise variance.

EM clustering methods attempt to learn mixture model parameters and then classify samples based on the optimal pdf. EM clustering estimates the most likely mixture distribution parameters. These maximum likelihood parameters define a pdf for sample classification. A common mixture model in EM clustering methods is the Gaussian mixture model (GMM) that is discussed next.

Gaussian Mixture Models

Gaussian mixture models sample from a convex combination of a finite set of Gaussian sub-populations. K is now the number of sub-populations. The GMM population parameters are the mixing proportions (convex coefficients) α₁, . . . , α_{K} and the pdf parameters θ₁, . . . , θ_{K} for each population. Bayes theorem gives the conditional pdf for the E-step.

The mixture model uses the following notation and definitions. Y is the observed mixed random variable. Z is the latent population index random variable. The joint pdf f(y,z|Θ) is

$$\begin{matrix}f ( y , z \vert Θ ) = {\sum }_{j = 1}^{K} {α}_{j} δ [ z - j ] f ( y \vert j , {θ}_{j} ) & ( 21 ) \\ where \\ f ( y \vert Θ ) = {\sum }_{j = 1}^{K} {α}_{j} f ( y \vert j , {θ}_{j} ) , & ( 22 ) \\ δ [ z - j ] = \{ \begin{matrix}1 & if z = j \\ 0 & if z \neq j\end{matrix} , & ( 23 ) \\ and \\ {p}_{Z} ( j \vert y , Θ ) = \frac{{α}_{j} f ( y \vert Z = j , {θ}_{j} )}{f ( y \vert Θ )} & ( 24 ) \\ for \\ Θ = \{ {α}_{1} , … , {α}_{K} , {θ}_{1} , … , {θ}_{K} \} . & ( 25 )\end{matrix}$$

The joint pdf an be rewritten in exponential form as follows:

$$\begin{matrix} f ( y , z \vert Θ ) = exp [ {\sum }_{j = 1}^{K} [ ln ( {α}_{j} ) + ln f ( y \vert j , {θ}_{j} ) ] δ [ z - j ] ] , & ( 26 ) \\ ln f ( y , z \vert Θ ) = {\sum }_{j = 1}^{K} δ [ z - j ] ln [ {α}_{j} f ( y \vert j , {θ}_{j} ) ] , & ( 27 ) \\ \begin{matrix}Q ( Θ \vert Θ ( t ) ) = {E}_{Z \vert y , {Θ}_{k}} [ ln f ( y , Z \vert Θ ) ] \\ = {\sum }_{z = 1}^{K} ( {\sum }_{j = 1}^{K} δ [ z - j ] ln [ {α}_{j} f ( y \vert j , {θ}_{j} ) ] ) \times {p}_{Z} ( z \vert y , Θ ( t ) ) ( 29 ) \\ = {\sum }_{j = 1}^{K} ln [ {α}_{j} f ( y \vert j , {θ}_{j} ) ] {p}_{Z} ( j \vert y , Θ ( t ) ) . ( 30 )\end{matrix} & ( 28 )\end{matrix}$$

Equation (30) states the E-step for the mixture model. The Gaussian mixture model (GMM) uses the above model with Gaussian subpopulation pdfs for f (y|j,θⱼ).

Suppose there are N data samples of the GMM distributions. The EM algorithm estimates the mixing probabilities αⱼ, the subpopulation means μⱼ, and the subpopulation covariance Σⱼ. The current estimate of the GMM parameters is Θ(t)={α₁(t), . . . , α_{K}(t), μ₁(t), . . . , μ_{K}(t), Σ₁(t), . . . , E_{K}(t)}. The iterations of the GMM-EM reduce to the following update equations:

$$\begin{matrix}{α}_{j} ( t + 1 ) = \frac{1}{N} {\sum }_{i = 1}^{N} {p}_{Z} ( j \vert {y}_{i} , Θ ( t ) ) & ( 31 ) \\ {μ}_{j} ( t + 1 ) = \frac{{\sum }_{i = 1}^{N} {p}_{Z} ( j \vert {y}_{i} , Θ ( t ) ) {y}_{i}}{{\sum }_{i = 1}^{N} {p}_{Z} ( j \vert {y}_{i} , Θ ( t ) )} & ( 32 ) \\ {\sum }_{j} ( t + 1 ) = \frac{{\sum }_{i = 1}^{N} {p}_{Z} ( j \vert {y}_{i} , Θ ( t ) ) ( {y}_{i} - {μ}_{j} ( t ) ) {( {y}_{i} - {μ}_{j} ( t ) )}^{T}}{{\sum }_{i = 1}^{N} {p}_{Z} ( j \vert {y}_{i} , Θ ( t ) )} . & ( 33 )\end{matrix}$$

These equations update the parameters αⱼ, μⱼ, and Σⱼ with coordinate values that maximize the Q function in (30) duda-hart-stork2001. The updates combine both the Esteps and Msteps of the EM procedure.

EM Clustering

EM clustering uses the membership probability density function p_{Z}(j|y, Θ_{EM}) as a maximum a posteriori classifier for each sample y. The classifier assigns y to the j^{th} cluster if p_{Z}(j|y,Θ_{EM})≧p_{Z}(k|y,Θ_{EM}) for all k≠j. Thus

$$EMclass ( y ) = {arg max}_{j} {p}_{Z} ( j \vert y , {Θ}_{EM} ) . \qquad ( 34 )$$

This is the naive Bayes classifier based on the EM-optimal GMM parameters for the data. NEM clustering uses the same classifier but with the NEM-optimal GMM parameters for the data:

$$NEMclass ( y ) = {arg max}_{j} {p}_{Z} ( j \vert y , {Θ}_{NEM} ) . \qquad ( 35 )$$

k-Means Clustering as a GMM-EM Procedure

k-means clustering is a non-parametric procedure for partitioning data samples into clusters. Suppose the data space R^{d} has K centroids μ₁, . . . , μ_{K}. The procedure tries to find K partitions D₁, . . . , D_{K} with centroids that minimize the within-cluster Euclidean distance from the cluster centroids:

$${arg min}_{{D}_{1} , … {D}_{K}} {\sum }_{j = 1}^{K} {\sum }_{i = 1}^{N} {‖ {y}_{i} - {μ}_{j} ‖}^{2} {\vert \vert}_{{D}_{j}} ( {y}_{i} ) \qquad ( 36 )$$

for N pattern samples y₁, . . . , y_{N}. The class indicator functions ∥_{D}_{₁}, . . . , ∥_{D}_{_{K}} arise from the nearest-neighbor classification in (38) below. Each indicator function ∥_{D}_{ⱼ} indicates the presence or absence of pattern y in Dⱼ:

$${\vert \vert}_{{D}_{j}} ( y ) = \{ \begin{matrix}1 & if y ∈ {D}_{j} \\ 0 & if y ∉ {D}_{j}\end{matrix} . \qquad ( 37 )$$

The k-means procedure finds local optima for this objective function. k-means clustering works in the following two steps:

### K-Means Clustering Algorithm

### Assign Samples to Partitions:

yᵢεDⱼ(t) if ∥yᵢ−μⱼ(t)∥≦∥yᵢ−μₖ(t) k≠j (38)

### Update Centroids:

$${μ}_{j} ( t + 1 ) = \frac{1}{\vert {D}_{j} ( t ) \vert} {\sum }_{i = 1}^{N} {y}_{i} {\vert \vert}_{{D}_{j} ( t )} ( {y}_{i} ) . \qquad ( 39 )$$

k-means clustering is a special case of the GMM-EM model. The key to this subsumption is the “degree of membership” function or “cluster-membership measure” m(j|y). It is a fuzzy measure of how much the sample yᵢ belongs to the j^{th} subpopulation or cluster. The GMM-EM model uses Bayes theorem to derive a soft cluster-membership function:

$$m ( j \vert y ) = {p}_{Z} ( j \vert y , Θ ) = \frac{{α}_{j} f ( y \vert Z = j , {θ}_{j} )}{f ( y \vert Θ )} . \qquad ( 40 )$$

k-means clustering assumes a hard cluster-membership:

m(j|y)=∥_{D}_{ⱼ}(Y) (41)

where Dⱼ is the partition region whose centroid is closest to y. The k-means assignment step redefines the cluster regions Dⱼ to modify this membership function. The procedure does not estimate the covariance matrices in the GMM-EM formulation.

Theorem 2: The Expectation-Maximization Algorithm Subsumes k-Means Clustering

Suppose that the subpopulations have known spherical covariance matrices Σⱼ and known mixing proportions αⱼ. Suppose further that the cluster-membership function is hard:

m(j|y)=∥_{D}_{ⱼ}(y) (42)

Then GMM-EM reduces to K-Means clustering:

$$\frac{{\sum }_{i = 1}^{N} {p}_{Z} ( j \vert {y}_{i} , Θ ( t ) ) {y}_{i}}{{\sum }_{i = 1}^{N} {p}_{Z} ( j \vert {y}_{i} , Θ ( t ) )} = \frac{1}{\vert {D}_{j} ( t ) \vert} {\sum }_{i = 1}^{N} {y}_{i} {\vert \vert}_{{D}_{j} ( t )} ( {y}_{i} ) . \qquad ( 43 )$$

Proof:

The covariance matrices Σⱼ and mixing proportions αⱼ are constant. So the update equations (31) and (33) do not apply in the GMM-EM procedure. The mean (or centroid) update equation in the GMM-EM procedure becomes

$${μ}_{j} ( t + 1 ) = \frac{{\sum }_{i = 1}^{N} {p}_{Z} ( j \vert {y}_{i} , Θ ( t ) ) {y}_{i}}{{\sum }_{i = 1}^{N} {p}_{Z} ( j \vert {y}_{i} , Θ ( t ) )} . \qquad ( 44 )$$

The hard cluster-membership function

mₜ(j|y)=∥_{D}_{ⱼ}₍ₜ₎(y) (45)

changes the t^{th} iteration's mean update to

$${μ}_{j} ( t + 1 ) = \frac{{\sum }_{i = 1}^{N} {y}_{i} {m}_{t} ( j \vert {y}_{i} )}{{\sum }_{i = 1}^{N} {m}_{t} ( j \vert {y}_{i} )} . \qquad ( 46 )$$

The sum of the hard cluster-membership function reduces to

$${\sum }_{i = 1}^{N} {m}_{t} ( j \vert {y}_{i} ) = {N}_{j} = \vert {D}_{j} ( t ) \vert \qquad ( 47 )$$

where Nⱼ is the number of samples in the j^{th} partition. Thus the mean update is

$${μ}_{j} ( t + 1 ) = \frac{1}{\vert {D}_{j} ( t ) \vert} {\sum }_{i = 1}^{N} {y}_{i} {\vert \vert}_{{D}_{j} ( t )} ( {y}_{i} ) . \qquad ( 48 )$$

Then, the EM mean update equals the k-means centroid update:

$$\frac{{\sum }_{i = 1}^{N} {p}_{Z} ( j \vert {y}_{i} , Θ ( t ) ) {y}_{i}}{{\sum }_{i = 1}^{N} {p}_{Z} ( j \vert {y}_{i} , Θ ( t ) )} = \frac{1}{\vert {D}_{j} ( t ) \vert} {\sum }_{i = 1}^{N} {y}_{i} {\vert \vert}_{{D}_{j} ( t )} ( {y}_{i} ) . \qquad ( 49 )$$

The known diagonal covariance matrices Σⱼ and mixing proportions αⱼ can arise from prior knowledge or previous optimizations. Estimates of the mixing proportions (31) get collateral updates as learning changes the size of the clusters.

Approximately hard cluster membership can occur in the regular EM algorithm when the subpopulations are well separated. An EM-optimal parameter estimate Θ* will result in very low posterior probabilities p_{Z}(j|y,Θ*) if y is not in the j^{th} cluster. The posterior probability is close to one for the correct cluster. Celeux and Govaert proved a similar result by showing an equivalence between the objective functions for EM and k-means clustering. Noise-injection simulations confirmed the predicted noise benefit in the k-means clustering algorithm.

k-Means Clustering and Adaptive Resonance Theory

k-means clustering resembles Adaptive Resonance Theory (ART). And so ART should also benefit from noise. k-means clustering learns clusters from input data without supervision. ART performs similar unsupervised learning on input data using neural circuits.

ART uses interactions between two fields of neurons: the comparison neuron field (or bottom-up activation) and the recognition neuron field (or top-down activation). The comparison field matches against the input data. The recognition field forms internal representations of learned categories. ART uses bidirectional “resonance” as a substitute for supervision. Resonance refers to the coherence between recognition and comparison neuron fields. The system is stable when the input signals match the recognition field categories. But the ART system can learn a new pattern or update an existing category if the input signal fails to match any recognition category to within a specified level of “vigilance” or degree of match.

ART systems are more flexible than regular k-means systems because ART systems do not need a pre-specified cluster count k to learn the data clusters. ART systems can also update the cluster count on the fly if the input data characteristics change. Extensions to the ART framework include ARTMAP for supervised classification learning and Fuzzy ART for fuzzy clustering. An open research question is whether NEM-like noise injection will provably benefit ART systems.

The Clustering Noise Benefit Theorem

The noise benefit of the NEM Theorem implies that noise can enhance EM-clustering. The next theorem shows that the noise benefits of the NEM Theorem extend to EM-clustering. The noise benefit occurs in misclassification relative to the EM-optimal classifier. Noise also benefits the k-means procedure as FIG. 2 shows since k-means is an EM-procedure. The theorem uses the following notation:
classₒₚₜ(Y)=argmax p_{Z}(j|Y,Θ*): EM-optimal classifier. It uses the optimal model parameters Θ*
P_{M}[k]=P(EMclassₖ(Y)≠classₒₚₜ(Y)): Probability of EM-clustering misclassification relative to classₒₚₜ using k^{th} iteration parameters
P_{M}_{_{N}}[k]=P(NEMclassₖ(Y)≠classₒₚₜ(Y)): Probability of NEM-clustering misclassification relative to classₒₚₜ using k^{th} iteration parameters

Theorem 3: Clustering Noise Benefit Theorem

Consider the NEM and EM iterations at the k^{th} step. Then the NEM misclassification probability P_{M}_{_{N}}[k] is less than the noise-free EM misclassification probability P_{M}[k]:

P_{M}_{_{N}}[k]≦P_{M}[k] (50)

when the additive noise N in the NEM-clustering procedure satisfies the NEM Theorem condition from (6):

$${E}_{Y , Z , N \vert {θ}^{*}} [ ln ( \frac{f ( Y + N , Z \vert {θ}_{k} )}{f ( Y , Z \vert {θ}_{k} )} ) ] \geq 0. \qquad ( 51 )$$

This positivity condition (51) in the GMM-NEM model reduces to the simple algebraic condition (19) osoba-mitaim-kosko2011, osoba-mitaim-kosko2012 for each coordinate i:

nᵢ└nᵢ−2(μⱼ_{ᵢ}−yᵢ)┘≦0 forallj

Proof: Misclassification is a mismatch in argument maximizations:

EMclassₖ(Y)≠classₒₚₜ(Y) if and only if argmax p_{Z}(j|Y,Θ_{EM}[k])≠argmax p_{Z}(j|Y,Θ*). (52)

This mismatch disappears as Θ_{EM} converges to Θ*. Thus

$$arg max {p}_{Z} ( j \vert Y , {Θ}_{EM} [ k ] ) convergesto arg max {p}_{Z} ( j \vert Y , {Θ}_{*} ) \\ since \\ {lim}_{k \to ∞} \vert \vert {Θ}_{EM} [ k ] - {Θ}_{*} \vert \vert = 0. \qquad ( 53 )$$

So the argument maximization mismatch decreases as the EM estimates get closer to the optimum parameter Θ*. But the NEM condition (54) implies that the following inequality holds on average at the k^{th} iteration:

∥Θ_{NEM}[k]−Θ*∥≦∥Θ_{EM}[k]−Θ*∥. (54)

Thus for a fixed iteration count k:

P(NEMclassₖ(Y)≠classₒₚₜ(Y))≦P(EMclassₖ(Y)≠classₒₚₜ(Y)) (55)

on average.

So

P_{M}_{_{N}}[k]≦P_{M}[k] (56)

on average. Thus noise reduces the probability of EM clustering misclassification relative to the EM-optimal classifier on average when the noise satisfies the NEM condition. This means that an unconverged NEM-classifier performs closer to the fully converged classifier than does an unconverged noise-less EM-classifier on average.

The noise-enhanced EM GMM algorithm in 1-D is stated next.

The D-dimensional GMM-EM algorithm runs the N-Step component-wise for each data dimension.

FIG. 1 shows a simulation instance of the predicted GMM noise benefit for 2-D cluster-parameter estimation. The Fig. shows that the optimum noise reduces GMM-cluster misclasssification by almost 30%.

### —Noisy GMM-EM Algorithm (1-D)

Require: y₁, . . . y_{N} GMM data samples

k=1

While.(||θₖ−θₖ₋₁P≧10^{-tol})do

### N-Step:

zᵢ=yᵢ+nᵢ (57)
where nᵢ is a sample of the truncated Gaussian:

$$N ( 0 , \frac{{σ}_{N}}{{k}^{2}} )$$

such that nᵢ└nᵢ−2(μⱼ_{ᵢ}−yᵢ)┘≦0 foralli, j

### E-Step:

$$Q ( Θ \vert Θ ( t ) ) = {\sum }_{i = 1}^{N} {\sum }_{j = 1}^{K} ln [ {α}_{j} f ( {z}_{i} \vert j , {θ}_{j} ) ] {p}_{Z} ( j \vert y , Θ ( t ) ) \qquad ( 58 )$$

### M-Step:

$${θ}_{k + 1} = {arg max}_{θ} \{ Q ( θ \vert {θ}_{k} ) \} \qquad ( 59 )$$

k=k+1

end while

\hat{θ}_{NEM}=θₖ. (60)

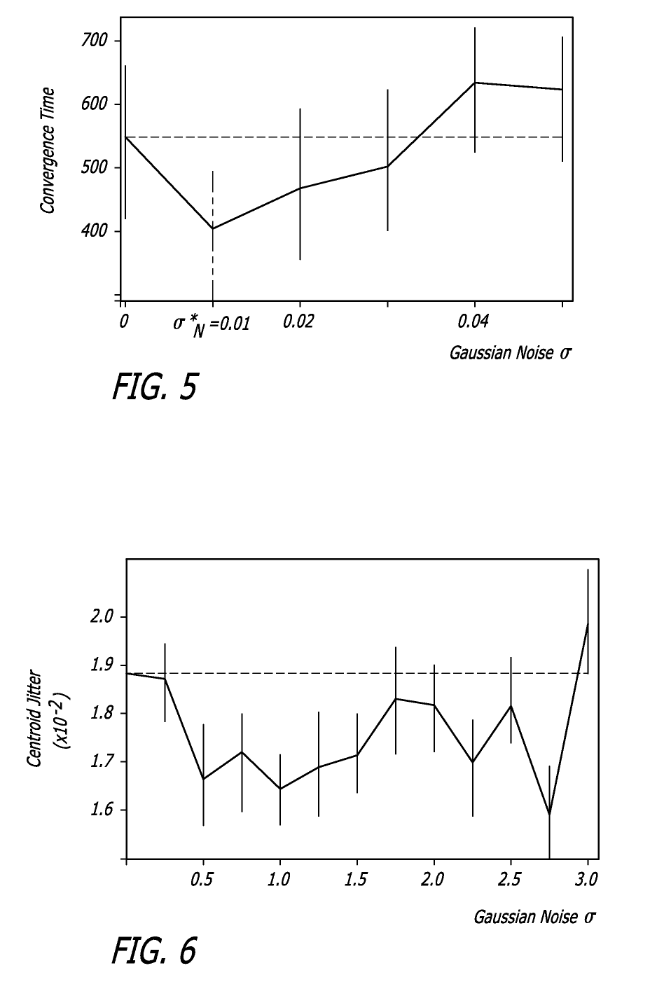

The competitive learning simulations in FIG. 5 used noisy versions of the competitive learning algorithms just as the clustering simulations used noisy versions. The noise was additive white Gaussian vector noise n with decreasing variance (annealed noise). The noise n was added to the pattern data y to produce the training sample z: z=y+n where n:N(0,Σ_{σ}(t)). The noise covariance matrix Σ_{σ}(t) was just the scaled identity matrix (t⁻²σ) for standard deviation or noise level σ>0. This allows the scalar σ to control the noise intensity for the entire vector learning process. The variance was annealed or decrased as Σ_{σ}(t)=(t²σ)I as in. So the noise vector random sequence n(1), n(2), . . . is an independent (white) sequence of similarly distributed Gaussian random vectors. For completeness, the three-step noisy UCL algorithm is stated.

Noise similarly perturbed the input patterns y(t) for the SCL and DCL learning algorithms. This leads to the following algorithm statements for SCL and DCL:

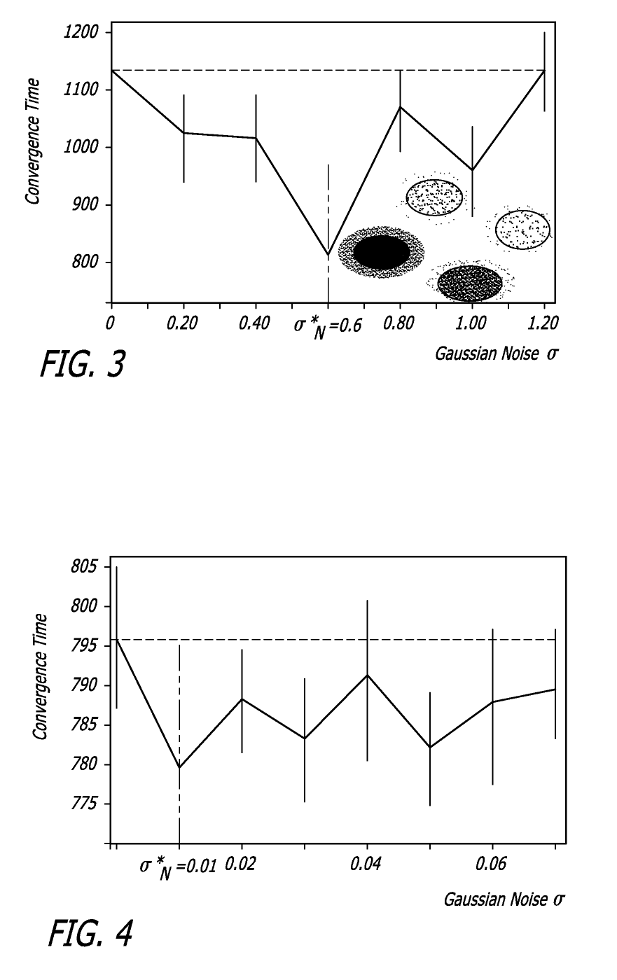

FIG. 3 shows that noise injection speeded up UCL convergence by about 25%. Noise benefit in the convergence time of Unsupervised Competitive Learning (UCL) is shown. The inset shows the four Gaussian data clusters with the same covariance matrix. The convergence time is the number of learning iterations before the synaptic weights stayed within 25% of the final converged synaptic weights. The dashed horizontal line shows the convergence time for UCL without additive noise. The Fig. shows that a small amount of noise can reduce convergence time by about 25%. The procedure adapts to noisy samples from a Gaussian mixture of four subpopulations. The subpopulations have centroids on the vertices of the rotated square of side-length 24 centered at the origin as the inset Fig. shows. The additive noise is zero-mean Gaussian.

FIG. 4 shows that noise injection speeded up SCL convergence by less than 5%. Noise benefit in the convergence time of Supervised Competitive Learning (SCL) is shown. The convergence time is the number of learning iterations before the synaptic weights stayed within 25% of the final converged synaptic weights. The dashed horizontal line shows the convergence time for SCL without additive noise. The Fig. shows that a small amount of noise can reduce convergence time by less than 5%. The procedure adapts to noisy samples from a Gaussian mixture of four subpopulations. The subpopulations have centroids on the vertices of the rotated square of side-length 24 centered at the origin as the inset in FIG. 3 shows. The additive noise is zero-mean Gaussian.

FIG. 5 shows that noise injection speeded up DCL convergence by about 20%. FIG. 5: Noise benefit in the convergence time of Differential Competitive Learning (DCL). The convergence time is the number of learning iterations before the synaptic weights stayed within 25% of the final converged synaptic weights. The dashed horizontal line shows the convergence time for DCL without additive noise. The Fig. shows that a small amount of noise can reduce convergence time by almost 20%. The procedure adapts to noisy samples from a Gaussian mixture of four subpopulations. The subpopulations have centroids on the vertices of the rotated square of side-length 24 centered at the origin as the inset in FIG. 3 shows. The additive noise is zero-mean Gaussian. All three Fig.s used the same four symmetric Gaussian data clusters in FIG. 3 (inset). Similar noise benefits for additive uniform noise was also observed.

### —Noisy UCL Algorithm

Noise Injection:

Define z(t)=y(t)+n(t)
for n(t):N(0, (t))Σ₉₄ (t))
   and annealing schedule

$${\sum }_{σ} ( t ) = \frac{σ}{{t}^{2}} I . \qquad ( 61 )$$

Pick the Noisy Winner:

The j^{th} neuron wins at t if

||z(t)−,μⱼ(t)||≦||z(t)−μₖ(t)||k≠j. (62)

### Update the Winning Quantization Vector:

μⱼ(t+1)=μⱼ(t)+cₜ└z(t)−μⱼ(t)┘ (63)

for a decreasing sequence of learning coefficients {cₜ}.

### —Noisy SCL Algorithm

Noise Injection:

Define z(t)=y(t)+n(t)
for n(t):N(0, Σ_{σ}(t))
   and annealing schedule

$${\sum }_{σ} ( t ) = \frac{σ}{{t}^{2}} I . \qquad ( 64 )$$

### Pick the Noisy Winner:

The j^{th} neuron wins at t if

||z(t)−μⱼ(t)||≦||z(t)−μₖ(t)||k≠j. (65)

### Update the Winning Quantization Vector:

μⱼ(t+1)=ⱼ(t)+cₜrⱼ(z)└z(t)−μⱼ(t)┘ (66)

where

$${r}_{j} ( z ) = {∣}_{{D}_{j}} ( z ) - {\sum }_{i \neq j} {∥}_{{D}_{i}} ( z ) \qquad ( 67 )$$

and {cₜ}is a decreasing sequence of learning coefficients.

### —Noisy DCL Algorithm

Noise Injection:

Define z(t)=y(t)+n(t)
for n(t):N(0, Σ_{σ}(t))
   and annealing schedule

$${\sum }_{σ} ( t ) = \frac{σ}{{t}^{2}} I . \qquad ( 68 )$$

The j^{th} neuron wins at t if

||z(t)−μⱼ(t)||≦||z(t)−μₖ(t)||k≠j. (69)

### Update the Winning Quantization Vector:

μⱼ(t+1)=ⱼ(t)+cₜΔSⱼ(zⱼ)└S(x)−μⱼ(t)┘ (70)

where

ΔSⱼ(zⱼ)=sgn └zⱼ(t+1)−zⱼ)(t)┘ (70)

and {cₜ} is a decreasing sequence of learning coefficients.

FIG. 6 shows how noise can also reduce the centroid estimate's jitter in the UCL algorithm for unsupervised competitive learning (UCL). The centroid jitter is the variance of the last 75 centroids of a UCL run. The dashed horizontal line shows the centroid jitter in the last 75 estimates for a UCL without additive noise. The plot shows that the some additive noise makes the UCL centroids more stationary. Too much noise makes the UCL centroids move more. The procedure adapts to noisy data from a Gaussian mixture of four subpopulations. The subpopulations have centroids on the vertices of the rotated square of side-length 24 centered at the origin as the inset in FIG. 3 shows. The additive noise is zero-mean Gaussian. The jitter is the variance of the last 75 synaptic fan-ins of a UCL run. It measures of how much the centroid estimates move after learning has converged.

The clustering techniques that are described herein may be used in various applications. Examples of such uses are now described.

Robotic and other automated computer vision systems may use these clustering methods to cluster objects in a robot's field-of-view. Robotic surgery may use such computer vision systems to identify biological structures during robotic medical surgery. These tools may take in a scene image and apply a number of clustering algorithms to the image to make this identification. The approaches discussed herein may reduce the time these clustering algorithms spend churning on scene data. The number of processing iterations may, for example, be reduced by about 30%.

Radar tracking and automatic targeting in fighter jets may use these clustering methods to identify threats on a scene. The scene data may run through standard clustering algorithms. The approaches discussed herein may reduce the time needed to cluster these scenes by, for example, up to 25%. The approaches discussed herein may also improve the accuracy of the clustering result during intermediate steps in the algorithm by, for example, up to 30%. So these systems may identify useful targets quicker.

Search companies may use similar methods to cluster users and products for more targeted advertising and recommendations. Data clustering may form the heart of many big-data applications, such as Google News, and collaborative filtering for Netflix-style customer recommendations. These recommendation systems may cluster users and make new recommendations based on what other similar users liked. The clustering task may be iterative on large sets of user data. The approaches discussed herein can reduce the time required for such intensive clustering. The approaches discussed herein can also achieve lower clustering misclassification rates for a fixed number of iterations. For example, the misclassification rates may be reduced by to 30% and clustering time may be reduced by up to 25%.

Speech recognition uses clustering for speaker identification and word recognition. Speaker identification methods cluster speech signals using a Gaussian mixture model. The approaches discussed herein can reduce the amount of data required to achieve standard misclassification rates. So speaker identification can occur faster.

Credit-reporting agencies and lenders may use these clustering techniques to classify high- and low-credit risk clusters or patterns of fraudulent behavior. This may inform lending policies. The agencies may apply clustering methods to historic consumer data to detect credit-worthiness and classify consumers into groups of similar risk profiles. The approaches discussed herein may reduce the time it takes to correctly identify risk profiles by up to 25%.

Document clustering may allow topic modeling. Topic modeling methods generate feature vectors for each document in a corpus of documents. They then pass these feature vectors through clustering algorithms to identify clusters of similar documents. These clusters of similar documents may represent the various topics present in the corpus of documents. The approaches discussed herein may lead to up to 30% more accurate classification of document topics. This may be especially true when the data set of documents is small.

DNA and genomic/proteomic clustering may be central to many forms of bioinformatics search and processing. These methods use clustering algorithms to separate background gene sequences from important protein-binding sites in the DNA sequences. The approaches discussed herein may reduce the clustering time by up to 25% and thereby locate such binding sites faster.

Medical imaging may use clustering for image segmentation and object recognition. Some image segmentation methods used tuned parameterized probabilistic Markov random field models to cluster and identify important sections of an image. The model tuning is usually a generalized EM method. The approaches discussed herein may reduce the model tuning time by up to 40% and reduce cluster misclassification rates by up to 30%.

Resource exploration may use clustering to identify potential pockets of oil or metal or other resources. These applications apply clustering algorithms to geographical data. The clustering algorithms can benefit from The approaches discussed herein. They may lead to up to 30% more accurate identification of resource rich pockets.

Statistical and financial data analyses may use clustering to learn and detect patterns in data streams. Clustering methods on these applications read in real-time data and learns separate underlying patterns from the data. The clustering method refines the learned patterns as more data flows in just like the competitive learning algorithms in out invention do. The approaches discussed herein may speed up the pattern learning by up to 25%. They may also find more stable or robust patterns in the data than prior art in this domain.

Inventory control may use clustering to identify parts likely to fail given lifetime data. Inventory control systems clusters historical lifetime data on parts to identify parts with similar failure modes and behaviors. The approaches discussed herein may yield lower misclassification rates, especially when historical parts data is sparse.

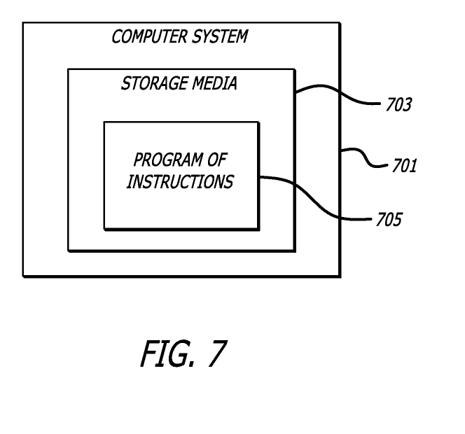

FIG. 7 shows a computer system 701 with storage media 703 containing a program of instructions 705. Unless otherwise indicated, the various algorithms that have been discussed herein may be implemented with the computer system 701 configured to perform these algorithms. The computer system 701 may include one or more processors, tangible storage media 703, such as memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The computer system 701 may include one or more computers at the same or different locations. When at different locations, the computers may be configured to communicate with one another through a wired and/or wireless network communication system.

The computer system 701 may include software (e.g., one or more operating systems, device drivers, application programs, and/or communication programs). When software is included, the software may include programming instructions 705 stored on the storage media 703 and may include associated data and libraries. When included, the programming instructions are configured to implement the algorithms, as described herein.

The software may be stored on or in one or more non-transitory, tangible storage medias, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The computer system 701, when running the program of instructions 705, may segregate a set of data into subsets that each have at least one similar characteristic by causing the computer system to perform any combination of one or more of the algorithms described herein.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, noise may be used to cluster data that is received in real-time, in sequential batches, or generally in an online fashion. Or noise may be used in a data clustering process wherein the number of clusters is automatically learned from the data. Or artificial physical noise may be used during clustering of chemical species (such as molecules, DNA, or RNA strands) using chemical or physical processes. Or generalized noise may be used in clustering of graph nodes or graph paths.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. Non-transitory, tangible, computer-readable storage media containing a program of instructions that enhances the performance of a computing system running the program of instructions when segregating a set of data into subsets that each have at least one similar characteristic by causing the computer system to perform operations comprising:
receiving the set of data;
applying an iterative clustering algorithm to the set of data that segregates the data into the subsets in iterative steps;
during the iterative steps, injecting perturbations into the data that have an average magnitude that decreases during the iterative steps; and
outputting information identifying the subsets.

2. The storage media of claim 1 wherein the iterative clustering algorithm includes a k-means clustering algorithm.

3. The storage media of claim 2 wherein the operations performed by the computer system while running the instructions include applying at least one prescriptive condition on the injected perturbations.

4. The storage media of claim 3 wherein at least one prescriptive condition is a Noisy Expectation Maximization (NEM) prescriptive condition.

5. The storage media of claim 1 wherein the iterative clustering algorithm includes a parametric clustering algorithm that relies on parametric data fitting.

6. The storage media of claim 5 wherein the operations performed by the computer system while running the instructions include applying at least one prescriptive condition on the injected perturbations.

7. The storage media of claim 6 wherein at least one prescriptive condition is a Noisy Expectation Maximization (NEM) prescriptive condition.

8. The storage media of claim 1 wherein the iterative clustering algorithm includes a competitive learning algorithm.

9. The storage media of claim 1 wherein the operations performed by the computer system while running the instructions include applying at least one prescriptive condition on the injected perturbations.

10. The storage media of claim 9 wherein at least one prescriptive condition is a Noisy Expectation Maximization (NEM) prescriptive condition.

11. The storage media of claim 1 wherein the perturbations are injected by adding them to the data.

12. The storage media of claim 1 wherein the average magnitude of the injected perturbations decrease with the square of the iteration count during the iterative steps.

13. The storage media of claim 1 wherein the average magnitude of the injected perturbations decrease to zero during the iterative steps.

14. The storage media of claim 13 wherein the average magnitude of the injected perturbations decrease to zero at the end of the iterative steps.
